(19) United States
(12) Patent Application Publication
(10) Pub. No.: US 2017/0101061 A1
(43) Pub. Date: Apr. 13, 2017

(54) QUICK CONNECT BRACKET

(71) Applicant: Andy Morris, Elkton, VA (US)

(72) Inventor: Andy Morris, Elkton, VA (US)

(21) Appl. No.: 14/877,054

(22) Filed: Oct. 7, 2015

(51) Int. Cl. B60R 9/06

(52) U.S. Cl. CPC B60R 9/06

(57) ABSTRACT

A connection bracket for use with a ATV vehicle that includes: at least one receiving plate, where the receiving plate attaches to the ATV; connecting rods that engage the at least one receiving plate; an horizontal extension extending from each connecting rod; a vertical extension extending from each horizontal extension; a top tube across the top of the vertical extensions; at least two mounting brackets on the top tube; and a hook extending from each mounting bracket. The connection bracket may further include adjustment holes along the length of the vertical extensions and a clamp on each vertical extension. Also, the connection bracket may further include adjustment holes along the length of the horizontal extensions.

### BACKGROUND OF THE INVENTION

Field of Invention

The present invention relates to a bracket that may be mounted on a four-wheel ATV.

Description of Related Art

Individuals who work around a farm or in the woods with a ATV four wheeler usually need to transport feed, tool buckets, back pack, gas cans, coolers, square bales and tree stands all on a rack that is normally provided on the rear of the ATV. More than likely once these items are place on the rear rack, the items can become dislodged during transport and the items tumble from the rack. Further even if the user is able to secure the items for transport, the items can become a safety hazard for the operator or another ATV operator who may be traveling behind the user when becoming dislodged.

Other brackets of the prior art attempt to address this storage problem, however these other brackets made for ATVs cannot be easily removed from the vehicle. Many brackets of the prior art require tools and time to remove and mount the brackets. The present invention does not require tools to be mounted or dismounted, which provides an advantage over the prior art. The brackets of the prior art are difficult to take off so most of the time users leave them on, thus causing a safety issue for the rider. The present invention eliminates this issue due to the easy removal and attachment capabilities associated with its use.

The present invention corrects ATV transport problems by providing a connection bracket that installs on the rear rack of an ATV. The connection bracket of the present invention provides safe and effective storage space for the ATV. The additional space enables the user to transport additional materials such as a feed bag or a back pack on the rear rack of the ATV.

### SUMMARY OF THE INVENTION

The present invention relates to a connection bracket for use with a ATV vehicle that includes: at least one receiving plate, where the at least one receiving plate attaches to the ATV; connecting rods that engage the at least one receiving plate; a horizontal extension extending from each connecting rod; a vertical extension extending from each horizontal extension; a top tube across the top of the vertical extensions; at least two mounting brackets on the top tube; and a hook extending from each mounting bracket. The connection bracket may further include adjustment holes along the length of the vertical extensions and a clamp on each vertical extension. Also, the connection bracket may further include adjustment holes along the length of the horizontal extensions.

### BRIEF DESCRIPTION OF DRAWINGS

FIG. 1A depicts a bracket used with ATV vehicles in accordance with the present invention.

FIG. 1B depicts a thumb-screw assembly used in accordance with the present invention.

FIG. 2 shows the bracket attached to an ATV utilizing a cooler attachment with a cooler in accordance with the present invention.

FIG. 3 shows the bracket attached to an ATV without the cooler attachment in accordance with the present invention.

### DETAILED DESCRIPTION

The present invention relates to a quick connect bracket that is used to transport a tree stand and/or other hunting equipment as necessary. The connect bracket according to the present invention includes an L-shaped frame that attaches to plate designed to be installed on an ATV. The bracket includes connection rods at the bottom that slide into openings in the plate. Clamps attach the bracket to a rack that is normally on the rear portion of the ATV. Hooks are provided for hanging a tree stand onto the bracket and a ratchet strip is used to secure the tree stand onto the bracket. Further, the bracket includes an additional cooler attachment that is attached to the bracket to mount a cooler onto the rear of the ATV.

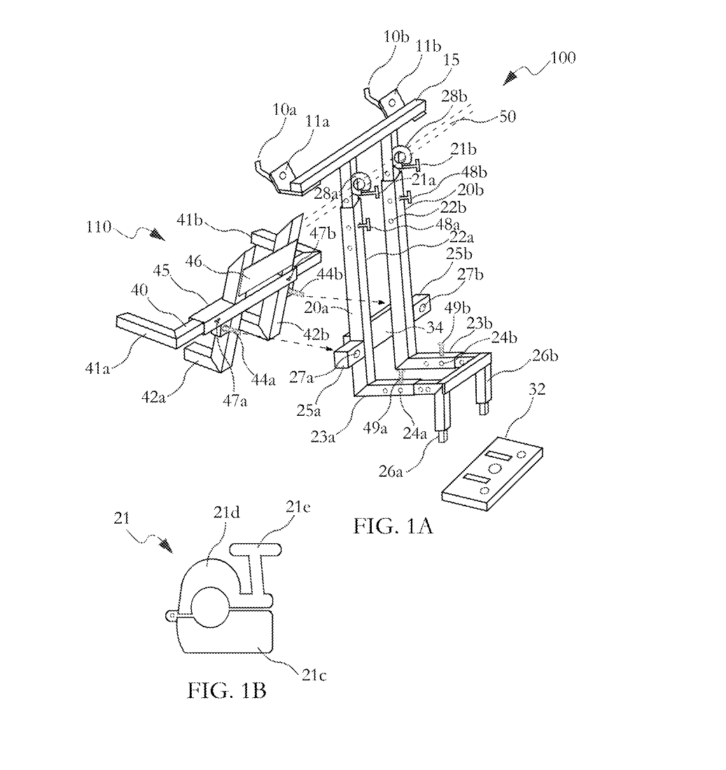

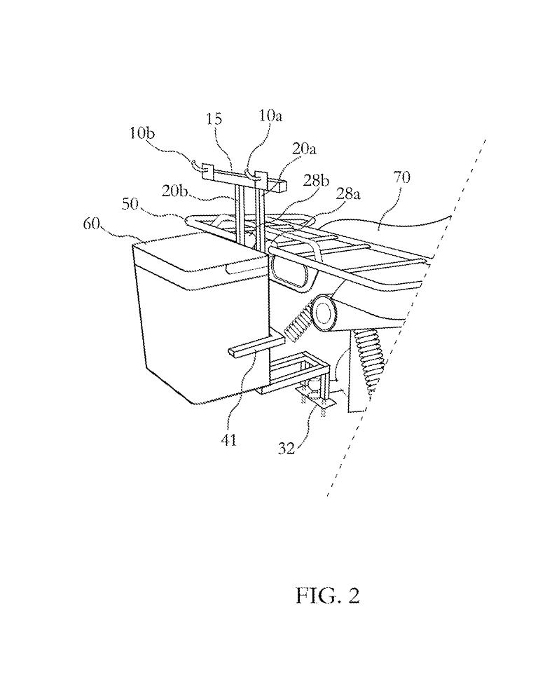

With respect to FIG. 1A, a connection bracket 100 is depicted. The connection bracket 100 includes various components. A receiver plate 32 is attached to an ATV vehicle and provides a means to connect the connection bracket 100 to the ATV. The receiver plate 32 receives connection rods 26a, 26b that extend from the main portion of the bracket 100. The connection rods 26a, 26b extend vertically from horizontal extensions 23a, 23b. Adjustment holes may be provided along the length of the horizontal extensions 23a, 23b to adjust the length of the horizontal extensions 23a, 23b and locked down with locking bolts 49a, 49b. Extending vertically on the opposite end of the horizontal extensions are vertical extensions 20a, 20b. The vertical extensions 20a, 20b may also include a series of adjustment holes 22a, 22b that adjust the vertical height of the bracket 100 and locked down by locking bolts 48a, 48b. On the inside of the bracket 100 are clamps 28a, 28b that clamp the bracket 100 into a stable position onto the rear rack of an ATV. A portion of a rear rack 50 is shown on FIG. 2 as it passes through the clamps 28a, 28b. Thumb screw assemblies 21a, 21b are shown with enable the tightening and placement of the clamps 28a, 28b around the rack 50. Connecting across the thumb screw assemblies 21a, 21b is a top square tube 15. The top square tube 15 includes mounting brackets 11a, 1 lb that each have a hook extending from each respective mounting bracket 11a, 11b. Hooks 10a, 10b and 11a, 11b receive a different style of tree stand for transport on the ATV. Also connecting between the vertical extensions 20a, 20b is a brace 34. The brace 34 may be used to receive a cooler attachment 110 as shown in FIG. 1. On each side of the brace 34 are receiving anchors 25a, 25b.

With respect to FIG. 1B, a thumb screw assembly 21 in accordance with the present invention is shown. This particular view shows the aspects of the thumb screw assembly 21 which enables the quick connection of the connection bracket 100 to a ATV rack. The thumb screw assembly 21 includes a thumb screw 21c that inserts through a top side 21d of clamps 28a, 28b. The top side 21d pivots open from a bottom side 21c. This quick opening aspect of the thumb screw assembly 21 enables the user to easily and quickly lock the connection bracket 100 onto the ATV rack.

The cooler attachment 110 attaches against the brace 34 through the receiving holes 27a, 27b. The receiving holes 27a, 27b receive connecting bolts 44a, 44b shown on the cooler attachment 110. The cooler attachment 110 also includes a horizontal tube 45 that encloses and receives a tube 40. The tube 40 includes arms that extend at a right angle from each end of the tube 40, arms 41a, 41b that are secured after adjustment with two locking bolts 47a, 47b. In addition to the tube 45, a back plate 46 is shown on the cooler attachment 110. L-shaped braces 42a, 42b support the cooler within the cooler attachment 110. The arms 41a, 41b prevent horizontal movement of the cooler once it is locked down with locking bolts 47a, 47b and secure with a ratchet strap onto the cooler attachment 110.

The connection bracket 100 may be used with the cooler attachment 110 or without it in order to transport equipment while participating in outdoor activities such as hunting. In particular, the connection bracket 100 is particularly useful in transporting tree stands for the hunter. Other equipment may be transported on the bracket 100 and as noted a cooler attachment 110 may be implemented to transport a cooler on the ATV.

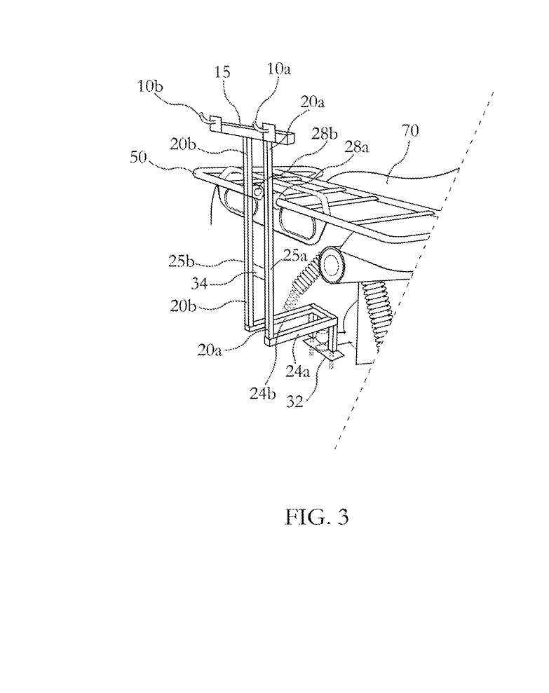

FIG. 2 shows the connection bracket 100 attached to an ATV 70. The connection bracket 100 is attached and secured to the ATV 70 with the clamps 28a, 28b around the rear rack 50. The clamps 28a, 28b provide a quick connection of the connection bracket 100 after the bracket 100 is inserted into the plate 32. As shown, a cooler 60 is placed between the arms 41. Receiver plate 32 is secured around a rear hitch of the ATV 70 and thus provides the lower support of the connection bracket 100. FIG. 3 depicts use of the bracket 100 on the ATV 70 without the cooler attachment 110. In this particular embodiment, the bracket 100 is available for use to transport other items such as a backpack, tree stand, hay or other equipment. The bracket 100 expands the transport capacity of the ATV and reduces potential hazards related thereto. The present invention has been shown and described in what it considers to be the most practical and preferred embodiments. It is recognized, however, that departures may be made there from within the scope of the invention and that obvious modifications will occur to a person skilled in the art.

What is claimed is:

1. A connection bracket for use with a ATV vehicle comprising:
a. a receiving plate, where the receiving plate attaches to the ATV;
b. connecting rods that engage the receiving plate;
c. a horizontal extension extending from each connecting rod;
d. a vertical extension extending from each horizontal extension;
e. a top tube across the top of the vertical extensions;
f. at least two mounting brackets on the top tube; and
g. a hook extending from each mounting bracket.

2. The connection bracket according to claim 1, further including adjustment holes along the length of the vertical extensions.

3. The connection bracket according to claim 2, further including a clamp on each vertical extension.

4. The connection bracket according to claim 1, further including adjustment holes along the length of the horizontal extensions.

5. The connection bracket according to claim 1, further including brace extending across vertical extensions at a midpoint of each vertical extension and said brace includes two receiving holes.

6. The connection bracket according to claim 5, further including a cooler attachment, where the cooler attachment engages with the brace.

7. The connection bracket according to claim 6, where the cooler attachment includes connecting bolts that go into the receiving holes.

8. The connection bracket according to claim 6, where the cooler attachment includes at least two L-shaped braces.

9. The connection bracket according to claim 8, where the cooler attachment includes a tube with arms, where the tube provides lateral support.

10. A connection bracket for use with a ATV vehicle comprising:
a. at least one receiving plate, where the at least one receiving plate attaches to the ATV;
b. connecting rods that engage the receiving plate;
c. a horizontal extension extending from each connecting rod;
d. a vertical extension extending from each horizontal extension;
e. a top tube across the top of the vertical extensions;
f. at least two mounting brackets on the top tube; and
g. a hook extending from each mounting bracket.
